(19) United States
(12) Patent Application Publication
(10) Pub. No.: US 2011/0147493 A1
(43) Pub. Date: Jun. 23, 2011

(54) METHOD FOR FORMING PERIODIC STRUCTURE AND FUEL INJECTION SYSTEM HAVING THE PERIODIC STRUCTURE

(75) Inventors: Yoshihito MITSUOKA, Toyota-city (JP); Kazunori Suzuki, Nagoya-city (JP); Yasuo Kitou, Okazaki-city (JP); Sumitomo Inomata, Toyota-city (JP)

(73) Assignee: DENSO CORPORATION, Kariya-city (JP)

(21) Appl. No.: 12/971,570

(22) Filed: Dec. 17, 2010

(30) Foreign Application Priority Data
Dec. 18, 2009 (JP) 2009-288104

(51) Int. Cl. F02M 63/00; B23K 26/00; B32B 3/30

(52) U.S. Cl. 239/533.2; 219/121.69; 428/600

(57) ABSTRACT

A method is for forming a periodic groove arrangement. According to the method, a base material made of metal is provided. Furthermore, the periodic groove arrangement, which includes a plurality of periodic grooves, is formed on a surface of the base material by irradiating and scanning the surface of the base material with a pulsed laser. A fuel injection system includes a nozzle hole forming part and the periodic groove arrangement formed by the method. The nozzle hole forming part includes a nozzle hole, which passes through the nozzle hole forming part and through which fuel is injected. The periodic groove arrangement is formed on an outer surface of the nozzle hole forming part.

### CROSS REFERENCE TO RELATED APPLICATION

This application is based on and incorporates herein by reference Japanese Patent Application No. 2009-288104 filed on Dec. 18, 2009.

### BACKGROUND OF THE INVENTION

1. Field of the Invention

The present invention relates to a method for forming a periodic structure on a solid surface and a fuel injection system having the periodic structure.

2. Description of Related Art

Conventionally, a fluorochemical film coating having liquid repellency that makes liquid droplets easily flow, is applied to a solid surface, on which the liquid droplets can be attached. The film is an organic substance. Accordingly, its liquid repellency is reduced in a high-temperature environment. For example, in a fuel injection system having an injection nozzle that injects fuel directly into a cylinder of an internal combustion engine, the injection nozzle is in an environment where the nozzle is exposed to combustion gas. As a result, a surface of the injection nozzle around an outlet of its nozzle hole is put into a high-temperature state, so that the fluorochemical film may deteriorate and the liquid repellency may decrease. Due to this reduction of liquid repellency, deposits are attached on the surface of the nozzle around the outlet of the nozzle hole. When the adhesion of deposits expands further to the interior of the nozzle hole, fuel injection quantity is reduced.

To solve a problem of the deterioration of the fluorochemical film, a technology described in JP-A-2006-220072 is known as a method whereby the reduction of liquid repellency due to heat is not easily caused. This conventional technology obtains the liquid repellency by forming depressions and projections having a fractal structure on an inner peripheral surface of a fuel nozzle hole in an injector and a surface around an opening part of the nozzle hole.

In the above conventional technology described in JP-A-2006-220072, the depressions and projections having the fractal shape are formed by the following methods (1) to (3). (1) A method for focused ion beam forming in which a gallium (Ga) ion beam is applied; (2) a method for forming aluminum anodized film; and (3) a method for alloying a powder mixture of nickel-chromium self-fluxing alloy and molybdenum on a base material surface by a laser.

However, by any of the above-described methods (1) to (3), it takes some time to form the depressions and projections having the fractal structure. Accordingly, they are undesirable in terms of productivity.

### SUMMARY OF THE INVENTION

The present invention addresses at least one of the above disadvantages.

According to the present invention, there is provided a method for forming a periodic groove arrangement. According to the method, a base material made of metal is provided. Furthermore, the periodic groove arrangement, which includes a plurality of periodic grooves, is formed on a surface of the base material by irradiating and scanning the surface of the base material with a pulsed laser.

According to the present invention, there is also provided a fuel injection system including a nozzle hole forming part and the periodic groove arrangement formed by the method. The nozzle hole forming part includes a nozzle hole, which passes through the nozzle hole forming part and through which fuel is injected. The periodic groove arrangement is formed on an outer surface of the nozzle hole forming part.

Furthermore, according to the present invention, there is provided a periodic structure including a base material and a periodic groove arrangement on a surface of the base material. The base material is made of metal. The periodic groove arrangement includes a plurality of periodic grooves.

In addition, according to the present invention, there is provided a fuel injection system including a nozzle hole forming part and the periodic groove arrangement. The nozzle hole forming part includes a nozzle hole, which passes through the nozzle hole forming part and through which fuel is injected. The periodic groove arrangement is formed on an outer surface of the nozzle hole forming part.

### BRIEF DESCRIPTION OF THE DRAWINGS

The invention, together with additional objectives, features and advantages thereof, will be best understood from the following description, the appended claims and the accompanying drawings in which:

FIG. 1 is a sectional view illustrating an example of an injector having a nozzle hole forming part, on which a periodic structure in accordance with the invention is formed;

FIG. 2 is a sectional view illustrating a periphery of the nozzle hole forming part in FIG. 1;

FIG. 3 is a sectional view in which the nozzle hole forming part in FIG. 2 is further enlarged;

FIG. 4 is a diagram illustrating a contact angle at periodic grooves formed on the nozzle hole forming part in FIG. 2;

FIG. 5 is an exemplary perspective view illustrating general shapes of periodic grooves in accordance with a first embodiment of the invention;

FIG. 6 is an enlarged exemplary perspective view illustrating a part of the periodic grooves in accordance with the first embodiment;

FIG. 7 is a diagram illustrating a process of forming the periodic grooves in accordance with the first embodiment;

FIG. 8 is a diagram illustrating a process of forming periodic grooves in accordance with a second embodiment of the invention;

FIG. 9 is a diagram illustrating a process of forming periodic grooves in accordance with a third embodiment of the invention;

FIG. 10 is an exemplary perspective view illustrating general shapes of periodic grooves in accordance with a fourth embodiment of the invention;

FIG. 11 is a diagram illustrating a process of forming the periodic grooves in accordance with the fourth embodiment;

FIG. 12 is an exemplary perspective view illustrating general shapes of periodic grooves in accordance with a fifth embodiment of the invention;

FIG. 13 is an enlarged exemplary perspective view illustrating a part of the periodic grooves in accordance with the fifth embodiment; and

FIG. 14 is a diagram illustrating a process of forming the periodic grooves in accordance with the fifth embodiment.

### DETAILED DESCRIPTION OF THE INVENTION

Embodiments of the present invention will be described below in reference to the accompanying drawings. In each embodiment, using the same numerals for the part corresponding to those described in the preceding embodiment(s), repeated descriptions may be omitted. In each embodiment, when only a part of the configuration is described, the previously described other embodiment(s) may be applied to the other parts of the configuration. In addition to the combination between the components whose combination is specifically shown to be possible in each embodiment, even if not clearly specified, a partial combination between embodiments may be possible unless the combination is particularly detrimental.

### First Embodiment

A first embodiment of the invention will be described with reference to the accompanying drawings. A periodic structure (periodic groove arrangement) including lines of grooves, which is described in the following embodiments, is formed on a region which requires liquid repellency (which is synonymous with water repellency) that repels liquid and makes liquid easily flow. In the first embodiment, an example of application of the periodic structure to a nozzle hole forming part in an injector 1, which is a fuel injection system, will be described.

The injector 1 is attached to a cylinder head of an engine, and is an injector for a direct injection gasoline engine. The injector for the direct injection gasoline engine injects fuel directly into a combustion chamber of the engine that is defined by a wall surface of the cylinder head, an inner wall surface of a cylinder block, and an upper end surface of a piston in a cylinder. Fuel pressurized into a pressure that is approximately equal to a fuel injection pressure by a fuel supply pump is supplied to the injector 1. This fuel pressure is set at a predetermined pressure in a range of 1 MPa to 40 MPa. The injector 1 injects fuel having the fuel injection pressure corresponding to that range into the combustion chamber. A spray of fuel injected from the injector 1 may is atomized to be diffused in the combustion chamber. This spray of fuel has a hollow conical shape, for example.

The injector 1 is disposed on a wall surface near a corner part of the combustion chamber in a slanted position, and inclined relative to a central axis of the injector 1 such that a fuel injection direction of the injector 1, i.e., a fuel spray separates toward the end face of a piston with respect to the central axis. An angle, at which the fuel spray is inclined relative to the central axis of the injector 1, is properly set at an optimal angle. Accordingly, the attachment of the spray of fuel to an ignition plug and an inner wall surface of the combustion chamber is limited.

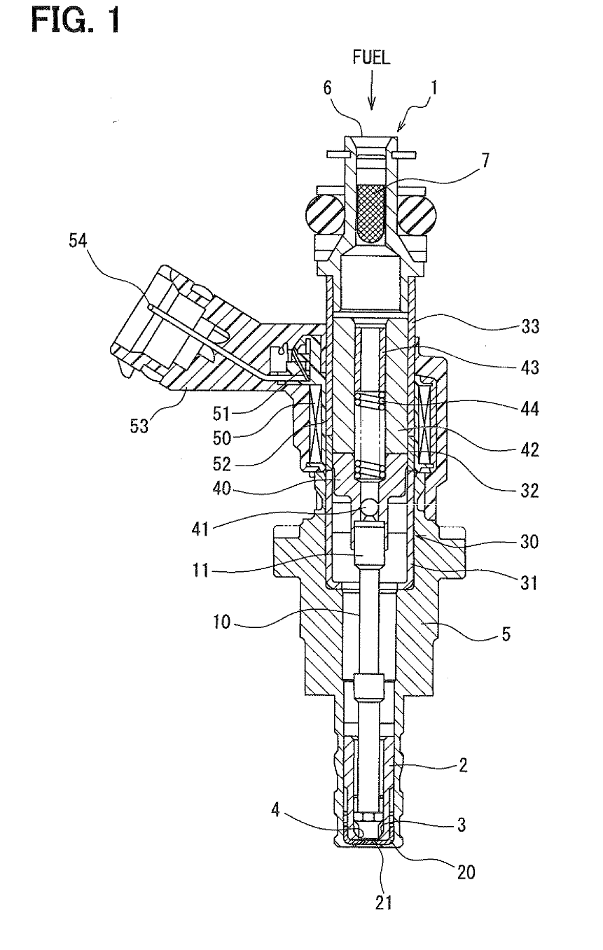

As illustrated in FIG. 1, a valve body 2 is fixed to an inner wall of a nozzle hole-side end portion of a valve housing 5 by welding, for example. The valve body 2 defines a fuel passage, and includes a conic surface 3 whose diameter is reduced toward a fuel downstream side. The conic surface 3 includes a valve seat 4 that a valve member 10 is engaged with or disengaged from.

A nozzle hole plate 20, which is the nozzle hole forming part, includes a nozzle hole 21. The plate 20 is formed at a front end of the injector 1 integrally or in a unified manner with the valve body 2. The nozzle hole plate 20 is formed in a cylindrical shape having a bottom, and integrally clamped between an inner wall of a bottom of the valve housing 5 and an outer wall of a bottom of the valve body 2.

A cylindrical member 30 is constituted of a first magnetic cylinder portion 31, a nonmagnetic cylinder portion 32, and a second magnetic cylinder portion 33, from the nozzle hole plate 20-side. The nonmagnetic cylinder portion 32 prevents a magnetic short circuit between the first magnetic cylinder portion 31 and the second magnetic cylinder portion 33.

A movable core 40 is formed into a cylindrical shape from a magnetic material, and fixed by such as welding to an end portion 11 of the valve member 10 on an opposite side from the nozzle hole 21. The movable core 40 reciprocates in cooperation with the valve member 10. The movable core 40 includes a communicating passage 41 passing through its interior, and the communicating passage 41 communicates with the fuel passage. A fixed core 42 is formed from a magnetic material, and arranged coaxially with the movable core 40. The fixed core 42 is inserted into the cylindrical member 30, and fixed by such as welding to the cylindrical member 30.

An adjusting pipe 43 is fixed by press fitting, for example, to the fixed core 42, and the fuel passage is formed inside the pipe 43. A spring 44 is disposed such that its both ends are clamped between the movable core 40 and the adjusting pipe 43. The spring 44 presses the movable core 40 and the valve member 10 in a direction in which the member 10 is engaged with the valve seat 4. By regulating the press-fitted amount of the adjusting pipe 43 which is press-fitted into the fixed core 42, urging force of the spring 44 is adjusted.

A drive coil 50 has a coil 51 and a spool 52. The spool 52 is formed into a cylindrical shape from a resin material, and the coil 51 is wound on its outer peripheral surface. Both ends of the wound coil 51 are electrically connected to a terminal area 54 of a connector 53. The fixed core 42 is disposed on an inner peripheral side of the drive coil 50 with the cylindrical member 30 located between the drive coil 50 and the fixed core 42.

When the drive coil 50 is not energized, the movable core 40 and the valve member 10 are pressed toward the valve seat 4, so that a seat part of the valve member 10 is engaged with the valve seat 4. Accordingly, fuel injection through the nozzle hole 21 is cut off. Upon energization of the drive coil 50, the movable core 40 is attracted to the fixed core 42, so that the valve member 10 is disengaged from the valve seat 4. As a result, fuel is injected through the nozzle hole 21. A state in which the valve member 10 is disengaged from the valve seat 4 is hereinafter referred to as time of the lift of the valve member 10. The lift amount of the valve member 10 is determined by an air gap between both magnetic pole faces of the movable core 40 and the fixed core 42.

Fuel is supplied to a fuel inlet part 6 of the injector 1 through the fuel supply pump. The fuel supplied through the fuel inlet part 6 flows along inner peripheral sides of the cylindrical member 30, the valve housing 5, and the valve body 2 through a filter 7 for removing foreign substances.

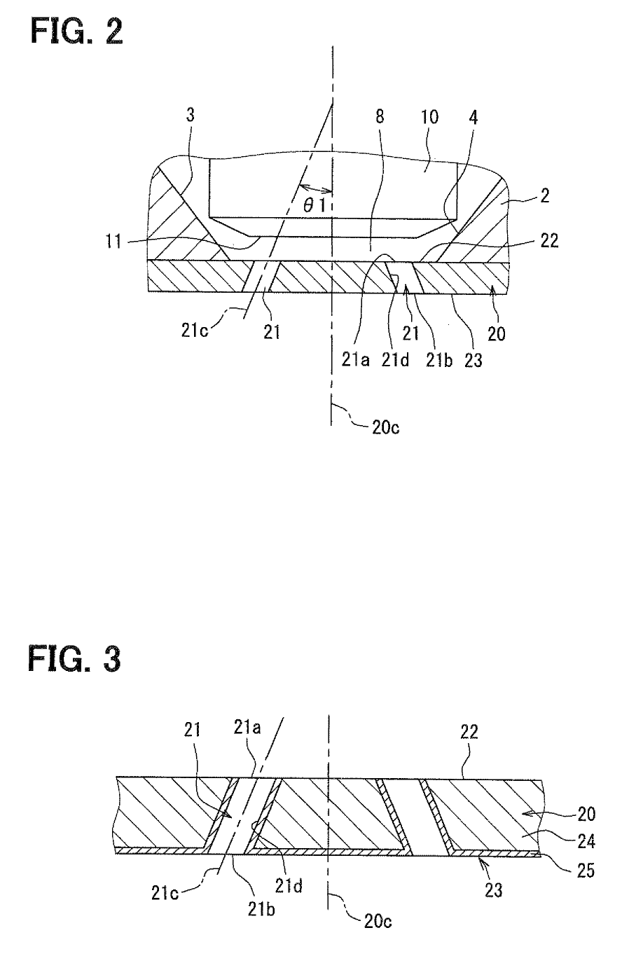

Next, the nozzle hole forming part in the injector 1 will be described. FIG. 2 is a sectional view illustrating the periphery of the nozzle hole plate 20 of the injector 1. FIG. 2 is the sectional view in which the front end part of the valve body 2 in FIG. 1 is enlarged. As illustrated in FIG. 2, the nozzle hole plate 20 is fixed integrally or in a unified manner to the front end part of the valve body 2. The nozzle hole plate 20, which is the nozzle hole forming part, includes the nozzle holes 21 radially inward of the conic surface 3. The nozzle holes 21 pass through the nozzle hole plate 20 and open on an inner surface 22 and an outer surface 23. The nozzle holes 21 are formed at intervals in the nozzle hole plate 20. The fuel supplied through the fuel inlet part 6 is injected into the combustion chamber of the engine through the nozzle hole 21.

Nozzle hole inlet parts 21a, which are inlet openings of the nozzle holes 21, are arranged on the same imaginary circle. More specifically, the nozzle hole inlet parts 21a are arranged on the imaginary circle in a shape of a single ring. The center of the imaginary circle generally coincides with the central axis of the injector 1. The center of the imaginary circle almost accords with a central axis 20c of the valve body 2 and the nozzle hole plate 20.

The nozzle hole 21 is formed radially inward of a recess defined by the conic surface 3 and the nozzle hole plate 20. A combustion chamber 8 defined by this recess and the valve member 10 is formed generally into a cylindrical shape. The fuel in the fuel passage leading from the valve seat 4-side into the nozzle hole 21 flows into the combustion chamber 8 when the valve member 10 is disengaged from the valve seat 4. The combustion chamber 8 has a function of distributing the fuel flowing into the combustion chamber 8 to each nozzle hole 21.

A direction of a central axis 21c of the nozzle hole 21 may be inclined such that a nozzle hole outlet part 21b, which is an outlet opening of the nozzle hole 21, is located on a side that is further away from the central axis 20c of the nozzle hole plate 20 than the nozzle hole inlet part 21a. Each nozzle hole outlet part 21b located on an outer surface of the nozzle hole plate 20 is located outward of the corresponding nozzle hole inlet part 21a in a radial direction of the nozzle hole plate 20.

The nozzle hole plate 20 includes a main body part 24, and a liquid repellent coat 25, which has a periodic groove (periodic groove arrangement) 250 including lines of grooves (a plurality of periodic grooves) 251 formed on the main body part 24. The liquid repellent coat 25 is formed on the outer surface 23 of the nozzle hole plate 20. Due to the presence of the periodic groove 250, the liquid repellent coat 25 has a function of lifting droplets of liquids such as water and fuel off the surface and of repelling and slipping them.

For example, with respect to residual fuel that remains in the nozzle hole 21 after completion of the fuel injection through the nozzle hole 21 and may become nucleuses of deposits, by the liquid repellent coat 25 formed around the nozzle hole outlet part 21b, the residual fuel is moved or repelled toward the outer surface around the nozzle hole 21 other than the nozzle hole outlet part 21b. On the other hand, at the time of fuel injection, even in the case of attachment of deposits on a nozzle hole inner peripheral wall surface 21d of the nozzle hole 21, the deposits are exfoliated off the nozzle hole inner peripheral wall surface 21d by the force of fuel at the time of injection, i.e., by fuel injection pressure.

As described above, by providing the liquid repellent coat 25 for the periphery of the nozzle hole outlet part 21b, it is hoped that remaining fuel attached around the outlet opening of the nozzle hole 21 is reduced and that the adhesion of deposits to the outlet opening of the nozzle hole 21 is thereby limited. As a result of the formation of the liquid repellent coat 25 on the nozzle hole inner peripheral wall surface 21d, the accumulation of layers of thin deposits on the nozzle hole inner peripheral wall surface 21d due to the repetition of the fuel injection and injection stop is limited.

The main body part 24 of the nozzle hole plate 20 is formed from an iron system metal material such as stainless steel (SUS). The main body part 24 may correspond to ‘a base material made of metal,’ and the outer surface 23 may correspond to ‘a surface of the base material’.

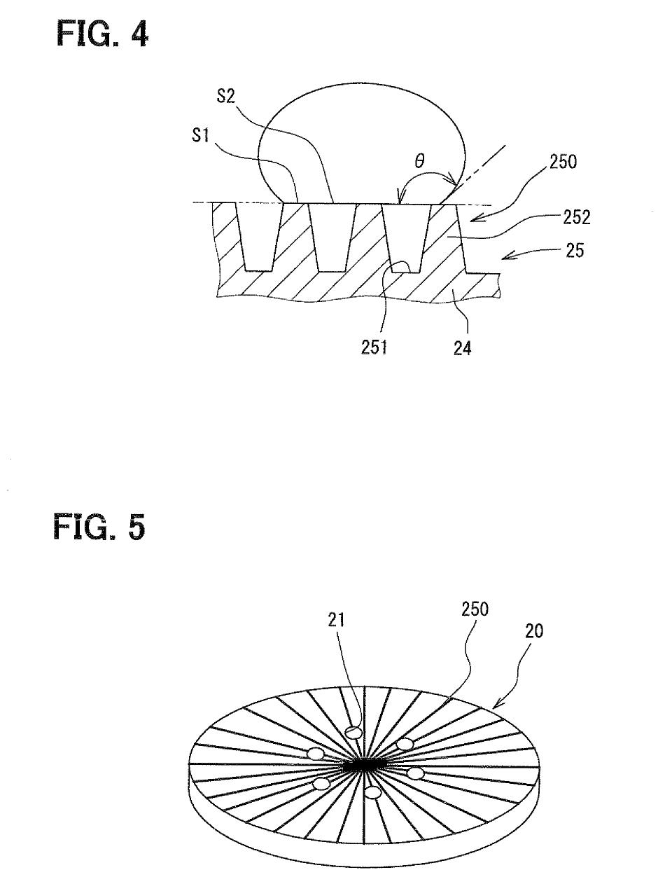

FIG. 4 schematically illustrates the periodic groove 250 that constitutes the liquid repellent coat 25.

On its outer surface 23, the liquid repellent coat 25 includes lines of grooves that are made up of a periodic arrangement of fine recessed striated portions 251 and projecting striated portions 252. As illustrated in FIG. 4, the recessed striated portions 251 and projecting striated portions 252 extend in a certain direction (direction perpendicular to a plane of paper of FIG. 4). These lines of grooves constitute the periodic groove 250 which is periodically repeated. Each projecting striated portion 252 is a projection having a trapezoidal shape, and formed such that their interval (hereinafter also referred to as a pitch) falls within a certain range. The grooves that are constituted of the recessed striated portions 251 (hereinafter also referred to as the grooves 251) are formed such that their pitch falls within a certain range, similar to the projecting striated portions 252. An upper direction in FIG. 4 corresponds to lower directions in FIGS. 1 to 3.

As illustrated in FIG. 4, in the periodic groove 250, the recessed striated portion 251 and the projecting striated portion 252, which are much smaller and finer than a size of the droplet of fuel, are formed on the outer surface 23 which is a surface of the main body part 24. The droplet of fuel is in contact with an air layer formed in the recessed striated portion 251 between the projecting striated portions 252, and the projecting striated portion 252. The droplet is supported by a top surface of the projecting striated portion 252 and the air layer. In regard to the surface with which the droplet is in contact, the proportion of the top surface of the projecting striated portion 252 is set at S1, and the proportion of the air layer is set at S2. A true contact angle of the metallic material at the projecting striated portion 252, i.e., the main body part 24 is set at θ1, and a true contact angle at the air layer is set at θ2.

A contact angle θ of the liquid repellent coat 25 with respect to the droplet is expressed in the following equation.

cos θ=S1×cos θ1+S2×cos θ2

In the case of the air layer, because of θ2=180, by setting the proportion S1 of the top surface of the projecting striated portion 252 to be small, the contact angle θ of the liquid repellent coat 25 is made large.

As illustrated in FIG. 5, the periodic groove 250 is formed into a radially extending shape on the outer surface 23 of the main body part 24. The periodic groove 250 is formed such that the lines of grooves 251, which are arranged at generally regular intervals in a circular arc shape in a range of 360 degrees from a central portion of the surface of the base material, extend radially. Accordingly, each width of the lines of projecting striated portions 252 is shorter at a region near the central portion than at a radially outward region of the surface of the base material. Therefore, a size of the air layer formed between the groove 251 and the droplet is larger at the region near the central portion than at the outward region, i.e., the proportion S1 is made smaller, and the contact angle θ of the liquid repellent coat 25 is made larger. Thus, the liquid droplets such as deposits are easily removed outward due to a jet flow produced at the time of fuel injection, and an of removal of the deposits is enhanced.

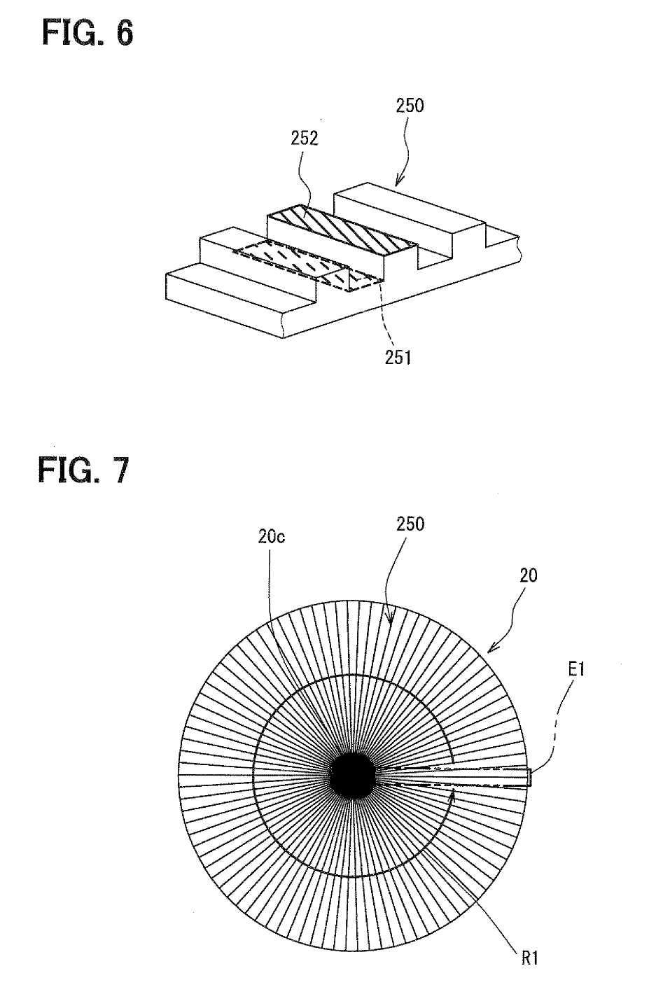

When the periodic groove 250 is enlarged and microscopically viewed as illustrated in FIG. 6, in the periodic groove 250, which is made up of radial periodic grooves, a portion (shaded area with a continuous line in FIG. 6) at which the liquid droplets are in contact with the projecting striated portion 252, and a portion (shaded area with a short dashes line in FIG. 6) at which the droplets are in contact with the air layer formed above the recessed striated portion (groove 251), have respective proportions of approximately 50%. The proportion of the portion at which the liquid droplet is in contact with the air layer becomes smaller at its outward region than at the region of the surface of the base material close to its central portion. This proportion becomes smaller further toward the outward region, to which the projecting striated portions 252 radially extend.

The liquid repellency is given to such a liquid repellent coat 25 due to the fine periodic groove 250 that is composed of the lines of grooves 251 formed on the surface of the base material instead of the organic substance like the fluorochemical film in the conventional technology. Accordingly, the liquid repellent coat 25 has excellent heat resistance compared to the liquid repellent coat made of organic substances.

A method for forming the nozzle hole plate 20 having the liquid repellent coat 25 will be described. A formation process of the nozzle hole plate 20 includes a main body part formation process and a periodic groove formation process.

In the main body part formation process, the nozzle hole plate 20 is formed from stainless steel (SUS). The nozzle hole 21 penetrated by press working for example is formed in the nozzle hole plate 20. In the periodic groove formation process, a predetermined periodic groove is formed by irradiating and scanning the outer surface 23 of the nozzle hole plate 20 with a pulsed laser. The periodic groove formation process may be undergone before the formation of the nozzle hole 21 in the nozzle hole plate 20, or the process may be undergone after the formation of the nozzle hole 21. In the case of carrying out the periodic groove formation process after the formation of the nozzle hole 21, the lines of grooves 251 are formed not only on the outer surface 23 of the nozzle hole plate 20 but also on the nozzle hole inner peripheral wall surface 21d in the periodic groove formation process.

If the periodic groove formation process is performed after the formation of the nozzle hole 21, the nozzle hole 21 needs to be formed in view of an optimal inner diameter of the nozzle hole 21 that is determined from required performance for the engine after the formation of the periodic groove.

In the periodic groove formation process, a predetermined region of the nozzle hole plate 20 is irradiated in a predetermined polarization direction with a femtosecond laser having a pulse width of 250 fs and a center wavelength of 800 nm, for example, using a plano-convex lens or a cylindrical lens, and the predetermined region is scanned by the laser in a predetermined direction. As illustrated in FIG. 7, a laser irradiation spot is a rectangular region E1 that is enclosed with an alternate long and two short dashes line. The polarization direction of the laser is set at a direction perpendicular to a radial direction in FIG. 7. A scanning direction R1 in which the predetermined region is scanned by the laser is a direction in which the laser is rotated to leave an arc-shaped locus with the central axis 20c of the nozzle hole plate 20 as its center. The region is one-revolution scanned with the laser under these conditions for the polarization direction and spot. Accordingly, the periodic groove 250 having the above-described shape is formed. Each groove 251 is formed to extend radially from the central axis 20c, and the periodic structure that is rotationally repeated is thereby formed.

As a result of implementation of such a periodic groove formation process, the periodic structure is formed such that the interval of the grooves 251 (pitch of the periodic structure) falls within a range of 700 nm to 800 nm. The contact angle θ of the liquid droplet at the liquid repellent coat 25 is well over 90 degrees, and the contact angle θ reaches about 128 degrees.

The wavelength conditions for the applied pulsed laser may be set in a range of 300 nm to 800 nm. The region E1, which is the laser irradiation spot, may be made up of a spot divided radially into more than one portion, and the region E1 may be scanned in multiple scannings, instead of the method of scanning by a single scanning in the radial direction from the central portion of the nozzle hole plate 20, as shown in the diagram. In the case of this method, a circular periodic groove is formed by the first scanning, and a periodic groove having a doughnut shape is formed for each scanning after the second scanning. Then, when the final scanning is completed, the radial periodic groove 250 is formed on the outer surface 23 of the nozzle hole plate 20.

By the method for forming the periodic groove 250 in accordance with the present embodiment, by irradiating and scanning the outer surface 23 of the nozzle hole plate 20 made of a metallic material with the above-described pulsed laser, the periodic groove 250 composed of the periodic lines of grooves 251 is formed on the outer surface 23. By means of this method, by irradiating and scanning the outer surface 23 of the nozzle hole plate 20 made of a metallic material with the pulsed laser, the periodic groove 250 in which the lines of microscopic grooves 251 are periodically arranged is formed like a self-organized structure. As a result of this formation of the periodic groove 250, the slippery contact angle of the droplet is made as described above, and the liquid repellent coat 25 is formed on the outer surface 23. Accordingly, if this method for forming the periodic groove is employed on a surface that requires liquid repellency of liquid, the outer surface 23 having excellent slip performance is obtained in a very short time without chemical preparation. Such a liquid repellent coat 25 is not the covering layer made of organic substances as in the conventional technology, and the repellent coat 25 is obtained as a result of the characteristic shape of the surface of the base material. Therefore, compared to the conventional liquid repellent coat made of organic substances, high heat resistance is achieved. The liquid repellent coat 25 realizes improvement in productivity, improvement in heat resistance, and inhibition of the adhesion of deposits around the nozzle hole 21. The repellent coat 25 greatly contributes to improvement in quality of the product of the injector 1.

By means of the method for forming the periodic groove 250, the outer surface 23 of the nozzle hole plate 20 is irradiated and scanned with the pulsed laser such that the lines of grooves 251, which constitute the periodic groove 250, extend radially on the outer surface 23. As a result of this method, by controlling the polarization direction and scanning direction of the pulsed laser so as to form the radially extending respective grooves 251, the periodic groove 250, which is composed of the radially extending fine respective grooves 251, is formed in a self-organized manner on the outer surface 23. By the formation of this periodic groove 250, the excellent liquid repellent coat 25 is formed on the outer surface 23. The liquid repellent coat 25 includes the radially extending respective grooves 251. Accordingly, the air layer formed between attachments, such as deposits adhering to the liquid repellent coat 25, and the groove 251, is formed in a radially extending manner. Consequently, the attachments easily slip in a direction in which the groove 251 extends, and the attachments easy flow in the direction in which the groove 251 extends radially. Therefore, the removal of the liquid droplets from the outer surface 23, on which the periodic groove 250 is formed, is promoted. Furthermore, the attachments such as deposits are made to easily flow outward of the nozzle hole plate 20. Accordingly, the attachments show a marked tendency to flow in a direction away from the nozzle hole 21, and reduction of fuel injection quantity due to such as clogging of the nozzle hole 21 is thereby limited.

By the method for forming the periodic groove 250, the radially extending lines of grooves 251 are formed by scanning the outer surface 23 of the nozzle hole plate 20 with the pulsed laser such that a circular arc-shaped locus (scanning direction R1) is left on the outer surface 23. As a result of this method, by scanning the surface of the base material in the scanning direction R1 with the pulsed laser, with the polarization direction of the pulsed laser set at a predetermined angle parallel to the radial direction from the central axis 20c, the periodic groove 250, which is constituted of the respective grooves 251 that extend radially outward, is produced accurately and efficiently. Thus, high product performance and productivity of the injector 1, which includes the nozzle hole plate 20 with the respective grooves 251 having a radially extending shape, are achieved.

By the method for forming the periodic groove 250, the outer surface 23 of the nozzle hole plate 20 may be irradiated with the angle of irradiation of the pulsed laser being changed relative to the outer surface 23 during the scanning of the pulsed laser such that the interval of the grooves 251 varies along the groove 251. In other words, the irradiation angle of the pulsed laser is set to be a predetermined angle (specific angle that is equal to or greater than 0 (zero) degree and that is smaller than 90 degrees) with respect to a direction perpendicular to the outer surface 23 of the plate 20, and this predetermined angle is varied during the scanning. Therefore, the surface of the base material is scanned with the angle relative to the surface of the base material at the time of the pulse laser irradiation being changed.

As a result of this method, by irradiating and scanning the outer surface 23 of the nozzle hole plate 20 with the irradiation angle of the pulsed laser changed such that the groove pitch of the periodic groove 250 changes along the direction of arrangement of the grooves 251, a contact area of the air layer formed between attachments adhering on the outer surface 23 of the nozzle hole plate 20 and the groove 251 with the attachments changes at a region of the change of the groove pitch. Accordingly, a static balance of the attachments is easily lost at the region of the change of the groove pitch. Hence, the attachments easily flow, and the removal of the attachments from the outer surface 23 is thereby promoted.

Moreover, by the method for forming the periodic groove 250, depths of the lines of grooves 251 may be changed along the grooves 251 with a scanning speed of the pulsed laser varied during the scanning. As a result of this method, a volume of the air layer formed between attachments adhering on the outer surface 23 of the nozzle hole plate 20 and the groove 251 changes at a region of the change of the groove depth along the periodic groove 250. Accordingly, a static balance of the attachments is easily lost at the region of the change of the groove depth. Hence, the attachments easily flow, and the removal of the attachments from the outer surface 23 is thereby promoted.

In addition, in the injector 1, the nozzle holes 21 are formed at intervals in the nozzle hole plate 20, and the nozzle hole outlet part 21b on the outer surface 23 of the nozzle hole plate 20 is located radially outward of its corresponding nozzle hole inlet part 21a. As a result of this configuration, fuel flows through the nozzle hole 21 from the radially inward portion toward the radially outward portion of the nozzle hole plate 20, and the fuel is injected to spread radially outward at the outer surface 23 of the nozzle hole plate 20. Such a jet flow of fuel produces an effect of blowing away the attachments such as deposits radially outward. Because of this effect, a flow moving the deposits or the like away from the nozzle hole 21 is formed. Therefore, the removal of the deposits or the like is promoted, and an effect of curbing the reduction of fuel injection quantity is further enhanced.

In the injector 1, the lines of grooves 251, which constitute the periodic groove 250, are formed not only on the outer surface 23 of the nozzle hole plate 20 but also on the nozzle hole inner peripheral wall surface 21d. As a result of this configuration, the liquid repellent coat 25 is produced on the nozzle hole inner peripheral wall surface 21d as well. Even when the deposits or the like enter into the nozzle hole 21, the deposits are made to easily flow to the outside because of their high fluidity. Thus, the effect of curbing the reduction of fuel injection quantity is further enhanced.

In the injector 1, the interval of the lines of grooves 251 located radially outward of the nozzle holes 21 is larger than the interval of the lines of grooves 251 located radially inward of the nozzle holes 21. As a result of this configuration, when the deposits or the like are attached on the outer surface 23 of the nozzle hole plate 20, the air layer formed between the groove 251 and the deposits is made larger at the region of the plate 20 inward of the nozzle holes 21 than at the outward region. Accordingly, the proportion of an area at which the deposits are in contact with the air layer to the entire area at which the deposits are in contact with the outer surface 23-side is larger at the inward region than at the nozzle hole 21. Thus, the deposits or the like easily flow further outward, and accumulation of the deposits inside the nozzle hole 21 is thereby prevented as well. As a result, the effect of curbing the reduction of fuel injection quantity is further enhanced.

### Second Embodiment

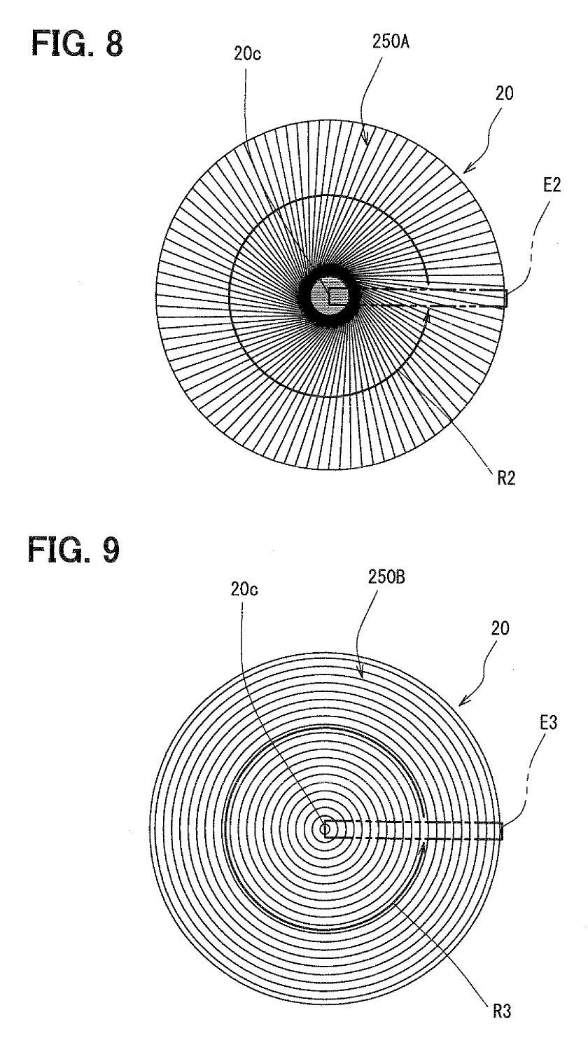

In a second embodiment of the invention, a periodic groove (periodic groove arrangement) 250A having a different shape from the periodic groove 250 will be described in reference to FIG. 8.

As illustrated in FIG. 8, radially extending lines of grooves 251, which constitute the periodic groove 250A, cross each other at a region of a nozzle hole plate 20 except a central axis 20c of the plate 20 (central portion of a surface of a base material). In other words, as opposed to the periodic groove 250 of the first embodiment, the periodic groove 250A is formed such that each groove 251 extends from a position shifted radially outward from the central axis 20c instead of the shape extending radially from the central axis 20c of the nozzle hole plate 20. Angles between directions, in which the respective grooves 251 extend, are set at a predetermined angle that is included in a range that is larger than 0 (zero) degree and that is smaller than 90 degrees with respect to a radial direction of an outer surface 23 of the nozzle hole plate 20.

In a periodic groove formation process for forming the periodic groove 250A, similar to the first embodiment, a predetermined region of the nozzle hole plate 20 is irradiated with the femtosecond laser having a pulse width of 250 fs and a center wavelength of 800 nm in a predetermined polarization direction through a plano-convex lens or a cylindrical lens, and the predetermined region of the plate 20 is scanned by the laser in a predetermined direction. As illustrated in FIG. 8, a laser irradiation spot is a rectangular region E2 that is enclosed with an alternate long and two short dashes line. The polarization direction of the laser is set at a predetermined angle included in a range that is larger than 0 (zero) degree and that is smaller than 90 degrees with respect to the radial direction in FIG. 8. A scanning direction R2 in which the predetermined region is scanned by the laser is a direction in which the laser is rotated to leave an arc-shaped locus with the central axis 20c of the nozzle hole plate 20 as its center. The region is one-revolution scanned with the laser under these conditions for the polarization direction and spot. Accordingly, the periodic groove 250A having the above-described shape is formed. Although the grooves 251 are not clearly formed in a predetermined region near the central axis 20c, the grooves 251 are formed to extend radially from the position shifted from the central axis 20c.

This is because the periodic groove is not clearly formed since in the circular region close to the central axis 20c, there is a portion in which the laser irradiations overlap many times, so that many grooves are formed to intersect with each other in a self-organized manner by the laser. The size of such a region in which a periodic groove is not formed is determined in accordance with an angle of the polarization direction of the laser.

In this periodic groove 250A, when enlarged and microscopically viewed, similar to the periodic structure (see FIG. 6) described in the first embodiment, a portion (shaded area with a continuous line in FIG. 6) at which liquid droplets are in contact with a projecting striated portion 252, and a portion (shaded area with a short dashes line in FIG. 6) at which the liquid droplets are in contact with the recessed striated portion 251 have respective proportions of approximately 50%. As a result of this periodic groove 250A, a contact area between the liquid droplets, such as deposits, and the air layer becomes large. Accordingly, a liquid repellent coat which is excellent in liquid repellency and on which the liquid droplets easily slip is provided.

By a method for forming the periodic groove 250A of the present embodiment, the outer surface 23 is irradiated and scanned with the pulsed laser such that the radially extending lines of grooves 251 cross at a region on the outer surface 23 of the nozzle hole plate 20 except the central portion (central axis 20c). As a result of this method, by forming the periodic groove 250A in a self-organized manner on the outer surface 23, the excellent liquid repellent coat 25 is formed on the outer surface 23. The liquid repellent coat 25 includes the grooves 251 extending in an involuted manner radially outward from the region except the central axis 20c, on the outer surface 23 of the nozzle hole plate 20. Accordingly, the air layer formed between attachments, such as deposits adhering to the liquid repellent coat 25, and the groove 251 is formed to extend outward of the nozzle hole plate 20. Therefore, the removal of attachments from the outer surface 23, on which the periodic groove 250A is formed, is promoted.

By the method for forming the periodic groove 250A, by scanning the outer surface 23 with the pulsed laser to leave an arc-shaped locus (scanning direction R2) on the outer surface 23 of the nozzle hole plate 20, with the polarization direction of the pulsed laser set at the predetermined angle included in a range that is larger than 0 (zero) degree and that is smaller than 90 degrees with respect to the radial direction, the radially extending lines of grooves 251 are formed. As a result of this method, the periodic groove 250A, which is constituted of the grooves 251 extending outward in an involuted manner, is produced accurately and efficiently. Thus, high product performance and productivity of the injector 1 that includes the nozzle hole plate 20 with each groove 251 having a shape extending in an involuted manner are achieved.

### Third Embodiment

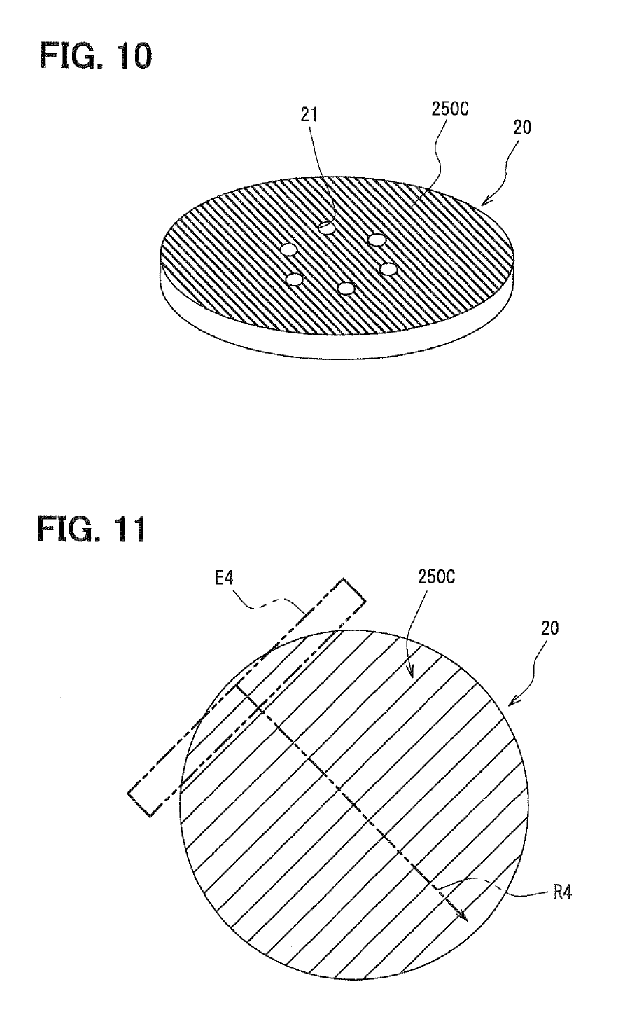

In a third embodiment of the invention, a periodic groove (periodic groove arrangement) 250B having a different shape from the periodic groove 250 will be described in reference to FIG. 9. As illustrated in FIG. 9, the lines of grooves 251, which constitute the periodic groove 250B, are formed concentrically, with a central axis 20c of a nozzle hole plate 20 (central portion of a surface of a base material) as their center.

In a periodic groove formation process for forming the periodic groove 250B, similar to the first embodiment, a predetermined region of the nozzle hole plate 20 is irradiated with the femtosecond laser having a pulse width of 250 fs and a center wavelength of 800 nm in a predetermined polarization direction through a plano-convex lens or a cylindrical lens, and the predetermined region of the plate 20 is scanned by the laser in a predetermined direction. As illustrated in FIG. 9, a laser irradiation spot is a rectangular region E3 that is enclosed with an alternate long and two short dashes line. The polarization direction of the laser is parallel to a radial direction in FIG. 9. A scanning direction R3 in which the predetermined region is scanned by the laser is a direction in which the laser is rotated to leave an arc-shaped locus with the central axis 20c of the nozzle hole plate 20 as its center. The region is one-revolution scanned with the laser under these conditions for the polarization direction and spot. Accordingly, the periodic groove 2508 perpendicular to the polarization direction is formed. The grooves 251 are formed concentrically with the central axis 20c being their center, and as the groove is located further outward, a radius of a circle drawn by its axis line becomes larger.

In this periodic groove 2508, when enlarged and microscopically viewed, similar to the periodic structure (see FIG. 6) described in the first embodiment, a portion (shaded area with a continuous line in FIG. 6) at which liquid droplets are in contact with a projecting striated portion 252, and a portion (shaded area with a short dashes line in FIG. 6) at which the liquid droplets are in contact with the recessed striated portion 251 have respective proportions of approximately 50%. As a result of this periodic groove 250B, a contact area between the liquid droplets, such as deposits, and the air layer becomes large. Accordingly, a liquid repellent coat which is excellent in liquid repellency and on which the liquid droplets easily slip is provided.

By means of the method for forming the periodic groove 250B of the present embodiment, the outer surface 23 of the nozzle hole plate 20 is irradiated and scanned with the pulsed laser such that the lines of grooves 251, which constitute the periodic groove 250B, extend concentrically on the outer surface 23 of the nozzle hole plate 20. As a result of this method, the periodic groove 2508, in which the concentrically extending fine grooves 251 are arranged periodically in a radial direction of the plate 20, is formed in a self-organized manner. Because of this formation of the periodic groove 250B, the slippery contact angle of the droplet is made as described above, and the liquid repellent coat 25 is formed on the outer surface 23. This liquid repellent coat 25 realizes improvement in productivity, improvement in heat resistance, and inhibition of the adhesion of deposits around the nozzle hole 21. The repellent coat 25 greatly contributes to improvement in quality of the product of the injector 1.

### Fourth Embodiment

In a fourth embodiment of the invention, a periodic groove (periodic groove arrangement) 250C having a different shape from the periodic groove 250 will be described in reference to FIGS. 10 and 11.

As illustrated in FIG. 10, the periodic groove 250C is formed such that lines of grooves 251 extend in one direction on an outer surface 23 of a nozzle hole plate 20. In other words, the periodic groove 250C is constituted of the lines of grooves 251, which are periodically repeated in a direction (scanning direction R4) perpendicular to the one direction. Each of the lines of grooves 251 is formed such that its axis line extends in the one direction on the nozzle hole plate 20 to cross over a nozzle hole outlet part 21b of a nozzle hole 21.

In a periodic groove formation process for forming the periodic groove 250C, similar to the first embodiment, an end portion of the nozzle hole plate 20 is irradiated with the femtosecond laser having a pulse width of 250 fs and a center wavelength of 800 nm in a predetermined polarization direction through a plano-convex lens or a cylindrical lens, and the end portion of the plate 20 is scanned in the direction (scanning direction R4) perpendicular to the one direction. A laser irradiation spot is a rectangular region E4 that is enclosed with an alternate long and two short dashes line, as illustrated in FIG. 11. The polarization direction of the laser is parallel to the scanning direction R4 in FIG. 11. The scanning direction R4 in which the end portion of the plate 20 is scanned with the laser is a direction from one peripheral edge part of the nozzle hole plate 20 toward the other peripheral edge part on the opposite side of the center of the plate 20 from the one peripheral edge part. The end portion of the plate 20 is scanned once with the laser under these conditions for the polarization direction and spot. Accordingly, the periodic groove 250C, in which the periodic grooves 251 are repeated in the above-described scanning direction R4, is formed.

Moreover, the region E4, which is a spot that is irradiated with the laser, may be a smaller spot instead of the method of scanning by a single scanning from one end portion of the nozzle hole plate 20 toward the other end portion of the plate 20, as illustrated in FIG. 11. In this case, by scanning the whole region of the nozzle hole plate 20 in multiple scannings, the periodic groove 250C is formed.

In this periodic groove 250C, when enlarged and microscopically viewed, similar to the periodic structure (see FIG. 6) described in the first embodiment, a portion (shaded area with a continuous line in FIG. 6) at which liquid droplets are in contact with a projecting striated portion 252, and a portion (shaded area with a short dashes line in FIG. 6) at which the liquid droplets are in contact with the recessed striated portion 251 have respective proportions of approximately 50%. As a result of this periodic groove 250C, a contact area between the liquid droplets, such as deposits, and the air layer becomes large. Accordingly, a liquid repellent coat which is excellent in liquid repellency and on which the liquid droplets easily slip is provided.

As a result of the implementation of such a periodic groove formation process, the contact angle θ of the liquid droplet at a liquid repellent coat 25 is well over 90 degrees, and the angle θ reaches nearly 130 degrees.

By means of the method for forming the periodic groove 250C of the present embodiment, the outer surface 23 of the nozzle hole plate 20 is irradiated and scanned with the pulsed laser such that the lines of grooves 251 extend in one direction on the outer surface 23. As a result of this method, the periodic groove 250C, which is composed of the fine respective grooves 251 extending in the one direction, is formed in a self-organized manner on the outer surface 23. By the formation of this periodic groove 250C, the excellent liquid repellent coat 25 is formed on the outer surface 23. This liquid repellent coat 25 includes the lines of grooves 251 extending in one direction. Accordingly, the air layer formed between attachments, such as deposits adhering to the liquid repellent coat 25, and the groove 251 is formed to extend in the one direction. Therefore, the attachments become slippery in the one direction in which the grooves 251 extend, and the attachments can flow in the one direction. Thus, the removal of attachments from the outer surface 23 is promoted.

### Fifth Embodiment

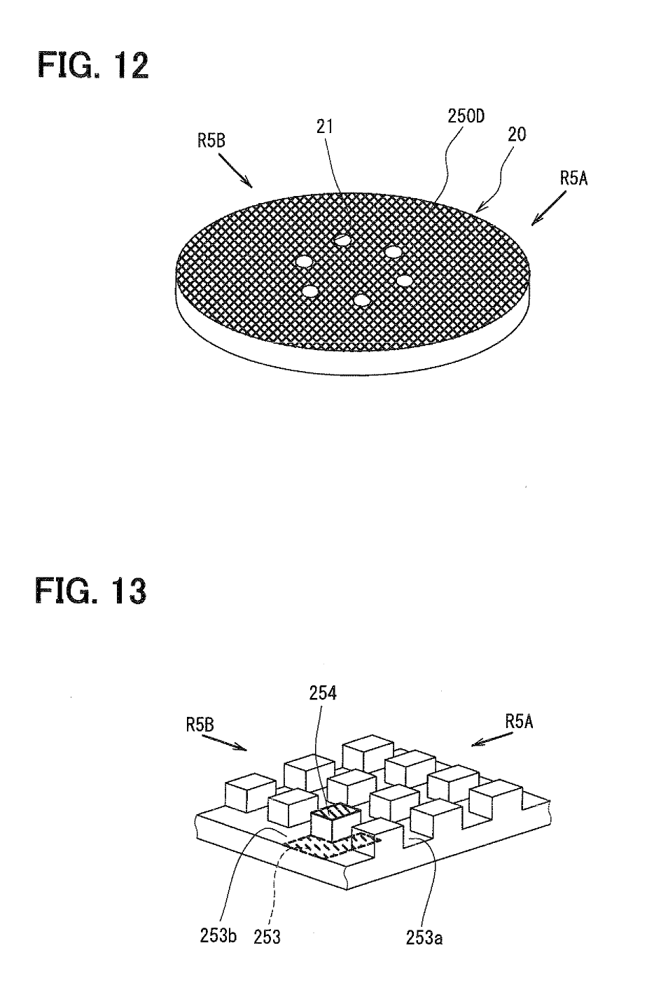

In a fifth embodiment of the invention, a periodic groove (periodic groove arrangement) 250D having a different shape from the periodic groove 250C extending in one direction will be described in reference to FIGS. 12 to 14.

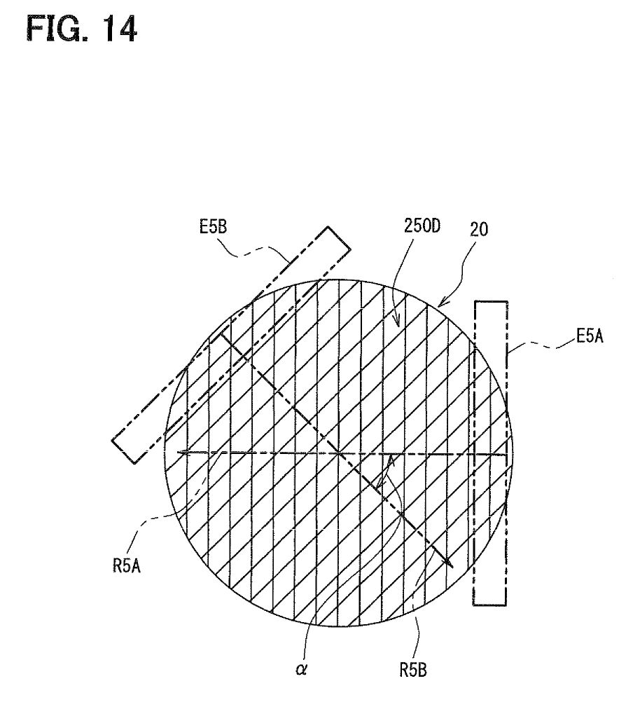

As illustrated in FIG. 12, the periodic groove 250D is composed of lines of grooves (a plurality of periodic grooves) 253a and lines of grooves (a plurality of periodic grooves) 253b arranged in two directions (a direction R5A and a direction R5B in FIG. 12) that intersect with each other on an outer surface 23 of a nozzle hole plate 20. In other words, the periodic groove 250D is made up of the lines of grooves 253a repeated periodically in the first direction (scanning direction R5A in FIG. 13), and the lines of grooves 253b repeated periodically in the second direction (scanning direction R5B in FIG. 14) that intersects with the first direction at an acute predetermined angle α (e.g., angle included in a range that is equal to or greater than 15 degrees and that is smaller than 90 degrees). The grooves 253a and the grooves 253b cross each other in a finely meshed pattern. Projections 254 are formed at regions on the nozzle hole plate 20, at which the grooves 253a and the grooves 253b are not formed.

As illustrated in FIG. 13, when the periodic groove 250D is enlarged and microscopically viewed, in the periodic groove 250D, which is constituted of the periodic grooves having a finely meshed pattern, a portion (shaded area with a continuous line in FIG. 13) at which liquid droplets are in contact with the projection 254 accounts for 25% of the entire outer surface 23, whereas a portion (shaded area with a short dashes line in FIG. 13) at which the liquid droplets are in contact with the air layer formed on the recessed striated portion (groove 253a and groove 253b) accounts for 75% of the entire surface 23. As a result of this periodic groove 250D, a contact area between the liquid droplets, such as deposits, and the air layer is made larger than the cases of the periodic grooves in the above embodiments. Accordingly, a liquid repellent coat which is excellent in liquid repellency and on which the liquid droplets easily slip is provided.

In a periodic groove formation process for forming the periodic groove 250D, similar to the first embodiment, an end portion of the nozzle hole plate 20 is irradiated with the femtosecond laser having a pulse width of 250 fs and a center wavelength of 800 nm in a predetermined polarization direction through a plano-convex lens or a cylindrical lens, and the end portion of the plate 20 is scanned in the scanning direction R5A and in the scanning direction R5B. Laser irradiation spots are rectangular regions E5A and E5B that are enclosed with an alternate long and two short dashes line, as illustrated in FIG. 14. The polarization direction of the laser is set to be parallel to the scanning direction R5A in FIG. 14 in the region E5A, and the polarization direction is set to be parallel to the scanning direction R5B in FIG. 14 in the region E5B. The scanning direction R5A in which the end portion of the plate 20 is scanned with the laser is a direction from a peripheral edge part of the nozzle hole plate 20 toward a peripheral edge part on the opposite side of the center. The scanning direction R5B is a direction that makes an acute predetermined angle α relative to the scanning direction R5A.

The region E5A and the region E5B are scanned respectively once with the laser under these conditions for the polarization direction and spot. Accordingly, the periodic groove 250D, in which periodic grooves 253 are repeated respectively in the scanning direction R5A and in the scanning direction R5B, is formed.

As a result of the implementation of such a periodic groove formation process, the contact angle θ of the liquid droplet at a liquid repellent coat 25 is well over 90 degrees, and the contact angle θ reaches nearly 132 degrees.

Each of the region E5A and the region E5B, which are spots that are irradiated with the laser, may be a smaller spot, instead of the method of scanning by a single scanning from one end portion toward the other end portion of the nozzle hole plate 20, as illustrated in FIG. 14. In this case, by scanning the whole region of the nozzle hole plate 20 in multiple scannings, the periodic groove 250D is formed.

By means of the method for forming the periodic groove 2500 of the present embodiment, by scanning the outer surface 23 of the nozzle hole plate 20 with the pulsed laser such that the pulsed laser proceeds in directions (scanning direction R5A and scanning direction R5B) which are perpendicular respectively to two directions (axis lines of the groove 253a and the groove 253b), the lines of grooves (a plurality of periodic grooves) 253 extending in the two crossed directions are formed.

As a result of this method, by controlling the polarization direction and scanning direction of the pulsed laser to form the grooves 253a, 253b extending respectively in two directions, the periodic groove 250D, which is composed of the fine grooves 253 extending in two directions, is formed in a self-organized manner on the outer surface 23 of the nozzle hole plate 20. By the formation of this periodic groove 250D, the excellent liquid repellent coat 25 is formed on the outer surface 23. The liquid repellent coat 25 includes the lines of grooves 253 extending in the two directions. Accordingly, attachments adhering to the liquid repellent coat 25 are in contact with the air layer at a larger area than the case in which the air layer extends in one direction as in the fourth embodiment. As a result, the attachments become slippery in both of the two directions, and the attachments can flow in the two directions. Thus, the removal of attachments from the outer surface 23 is promoted.

The method for forming the periodic groove 250D may include the irradiation and scanning of the pulsed laser such that the lines of grooves 253 in the crossed two directions define grooves in two directions whose intervals differ. As a result of this method, by controlling the irradiation and scanning using the pulsed lasers having different wavelengths for example or by converting a wavelength of the pulsed laser by means of an nonlinear optical effect such that the intervals of the grooves are different in direction unit, the air layers, which are formed between the attachments adhering on the outer surface 23 of the nozzle hole plate 20, and the grooves 253a, 253b in respective directions, have different contact areas with the attachments. Therefore, the attachments easily lose balance for resting on the outer surface 23. Accordingly, the attachments become slippery in one of the directions, for example, and the attachments cannot stably stand still so that they can flow. Thus, the removal of attachments from the outer surface 23 is promoted.

The method for forming the periodic groove 250D may include the formation such that by changing a speed of the scanning of the pulsed laser for each of directions perpendicular respectively to the crossed two directions, the depths of the grooves 253a, 253b in the crossed two directions are different. As a result of this method, by controlling the scanning of the pulsed laser such that the depths of the grooves differ in direction unit, the air layers formed between the liquid droplets attached on the outer surface 23 of the nozzle hole plate 20, and the grooves 253a, 253b in respective directions, have different volumes. Therefore, the attachments easily lose balance for resting on the outer surface 23. Accordingly, the attachments become slippery in one of the directions, for example, and the attachments cannot stably stand still so that they can flow. Thus, the removal of attachments from the outer surface 23 is promoted.

The plurality of periodic grooves 251, 253a, 253b, or 253, which constitute the periodic groove arrangement 250, 250A, 2506, 250C, or 250D, may be formed such that an interval among the plurality of periodic grooves 251, 253a, 253b, or 253 located radially outward of the nozzle hole 21 is larger than an interval among the plurality of periodic grooves 251, 253a, 253b, or 253 located radially inward of the nozzle hole 21.

Accordingly, an occupancy rate of the grooves per unit area is made larger at the radially inward region than at the radially outward region. Therefore, when attachments, such as deposits, are adhered on the outer surface 23 of the nozzle hole forming part 20, a ratio of the air layer formed between the grooves and attachments is larger at the region radially inward of the nozzle holes 21 than at the radially outward region. Thus, a rate of the area at which the attachments are in contact with the air layer with respect to the entire area at which the attachments are in contact with the outer surface 23 of the nozzle hole forming part 20 is made larger at the region inward of the nozzle holes 21. As a result, the attachments are removed from the inward region, and the attachments easily flow radially outward. Hence, accumulation of the attachments inside the nozzle hole 21 is prevented, so that the inhibition of reduction of fuel injection quantity is achieved.

Additional advantages and modifications will readily occur to those skilled in the art. The invention in its broader terms is therefore not limited to the specific details, representative apparatus, and illustrative examples shown and described.

What is claimed is:

1. A method for forming a periodic groove arrangement, comprising:
providing a base material made of metal;
forming the periodic groove arrangement, which includes a plurality of periodic grooves, on a surface of the base material by irradiating and scanning the surface of the base material with a pulsed laser.

2. The method according to claim 1, wherein the forming of the periodic groove arrangement includes forming the plurality of periodic grooves by the irradiating and scanning of the surface of the base material with the pulsed laser such that each of the plurality of periodic grooves radially extends on the surface of the base material.

3. The method according to claim 2, wherein the forming of the periodic groove arrangement includes forming the plurality of periodic grooves by the irradiating and scanning of the surface of the base material with the pulsed laser such that two or more of the plurality of periodic grooves intersect with each other at a portion of the surface of the base material, which is located radially outward of a center portion of the surface of the base material.

4. The method according to claim 2, wherein the scanning of the surface of the base material includes scanning the surface of the base material with the pulsed laser so as to leave a circular arc-shaped locus on the surface of the base material.

5. A fuel injection system comprising:
a nozzle hole forming part that includes at least one nozzle hole, which passes through the nozzle hole forming part and through which fuel is injected; and
the periodic groove arrangement formed by the method according to claim 2, wherein the periodic groove arrangement is formed on an outer surface of the nozzle hole forming part.

6. The fuel injection system according to claim 5, wherein:
the at least one nozzle hole includes a plurality of nozzle holes formed in the nozzle hole forming part at intervals; and
an outlet opening of each of the plurality of nozzle holes on the outer surface of the nozzle hole forming part is located radially outward of an inlet opening of the each of the plurality of nozzle holes on an inner surface of the nozzle hole forming part.

7. The method according to claim 1, wherein the forming of the periodic groove arrangement includes forming the plurality of periodic grooves by the irradiating and scanning of the surface of the base material with the pulsed laser such that each of the plurality of periodic grooves extends in one direction on the surface of the base material.

8. The method according to claim 1, wherein the forming of the periodic groove arrangement includes forming the plurality of periodic grooves by the irradiating and scanning of the surface of the base material with the pulsed laser such that a first group of the plurality of periodic grooves extends in a first direction on the surface of the base material and a second group of the plurality of periodic grooves extends in a second direction on the surface of the base material, the first direction and the second direction intersecting with each other.

9. The method according to claim 8, wherein the forming of the periodic groove arrangement includes forming the plurality of periodic grooves by the irradiating and scanning of the surface of the base material with the pulsed laser such that the first group of the plurality of periodic grooves is arranged at intervals of a first distance and the second group of the plurality of periodic grooves is arranged at intervals of a second distance, the first distance being different from the second distance.

10. The method according to claim 8, wherein the scanning of the surface of the base material includes scanning the surface of the base material with the pulsed laser in two directions that are perpendicular respectively to the first direction and the second direction.

11. The method according to claim 8, wherein the forming of the periodic groove arrangement includes forming the plurality of periodic grooves by the scanning of the surface of the base material with the pulsed laser in two directions that are perpendicular respectively to the first direction and the second direction, respective speeds of the scanning of the surface in the two directions being different, such that a depth of each of the first group of the plurality of periodic grooves is different from a depth of each of the second group of the plurality of periodic grooves.

12. The method according to claim 1, wherein the forming of the periodic groove arrangement includes forming the plurality of periodic grooves by the scanning of the surface of the base material with the pulsed laser with an irradiation angle of the pulsed laser relative to the surface of the base material changed during the scanning such that an interval among the plurality of periodic grooves differs between before and after the change of the irradiation angle.

13. The method according to claim 1, wherein the forming of the periodic groove arrangement includes forming the plurality of periodic grooves by the scanning of the surface of the base material with the pulsed laser with a scanning speed of the pulsed laser changed during the scanning such that a depth of each of the plurality of periodic grooves before the change of the scanning speed differs from a depth of each of the plurality of periodic grooves after the change of the scanning speed.

14. A fuel injection system comprising:
a nozzle hole forming part that includes a nozzle hole, which passes through the nozzle hole forming part and through which fuel is injected; and
the periodic groove arrangement formed by the method according to claim 1, wherein the periodic groove arrangement is formed on an outer surface of the nozzle hole forming part.

15. The fuel injection system according to claim 14, wherein the plurality of periodic grooves, which constitute the periodic groove arrangement, is formed also on an inner peripheral wall surface of the nozzle hole.

16. The fuel injection system according to claim 14, wherein the plurality of periodic grooves, which constitute the periodic groove arrangement, is formed such that an interval among the plurality of periodic grooves located radially outward of the nozzle hole is larger than an interval among the plurality of periodic grooves located radially inward of the nozzle hole.

17. A periodic structure comprising:
a base material made of metal; and
a periodic groove arrangement, which includes a plurality of periodic grooves, on a surface of the base material.

18. The periodic structure according to claim 17, wherein each of the plurality of periodic grooves radially extends on the surface of the base material.

19. The periodic structure according to claim 18, wherein two or more of the plurality of periodic grooves intersect with each other at a portion of the surface of the base material, which is located radially outward of a center portion of the surface of the base material.

20. A fuel injection system comprising:
a nozzle hole forming part that includes a nozzle hole, which passes through the nozzle hole forming part and through which fuel is injected; and
the periodic groove arrangement recited in claim 18, wherein the periodic groove arrangement is formed on an outer surface of the nozzle hole forming part.

21. The periodic structure according to claim 17, wherein each of the plurality of periodic grooves extends in one direction on the surface of the base material.

22. The periodic structure according to claim 17, wherein a first group of the plurality of periodic grooves extends in a first direction on the surface of the base material and a second group of the plurality of periodic grooves extends in a second direction on the surface of the base material, the first direction and the second direction intersecting with each other.

23. The periodic structure according to claim 22, wherein the first group of the plurality of periodic grooves is arranged at intervals of a first distance and the second group of the plurality of periodic grooves is arranged at intervals of a second distance, the first distance being different from the second distance.

24. The periodic structure according to claim 22, wherein a depth of each of the first group of the plurality of periodic grooves is different from a depth of each of the second group of the plurality of periodic grooves.

25. The periodic structure according to claim 17, wherein an interval among the plurality of periodic grooves changes at least once.

26. The periodic structure according to claim 17, wherein:
the plurality of periodic grooves includes at least two groups of periodic grooves;
adjacent two groups of the at least two groups of periodic grooves include a first group of periodic grooves and a second group of periodic grooves; and
a first depth of each of the first group of periodic grooves is different from a second depth of each of the second group of periodic grooves.

27. A fuel injection system comprising:
a nozzle hole forming part that includes a nozzle hole, which passes through the nozzle hole forming part and through which fuel is injected; and
the periodic groove arrangement recited in claim 17, wherein the periodic groove arrangement is formed on an outer surface of the nozzle hole forming part.
